(19) United States
(12) Patent Application Publication
(10) Pub. No.: US 2005/0060570 A1
(43) Pub. Date: Mar. 17, 2005

(54) Data recorder, data player, playing program, and recording program

(75) Inventor: Yutaka Ueda, Tokyo (JP)

Correspondence Address: Finnegan, Henderson, Farabow,;Garrett & Dunner, L.L.P., 1300 I Street, N.W., Washington, DC, 20005-3315, US

(73) Assignee: KONICA MINOLTA PHOTO IMAGING, INC.

(21) Appl. No.: 10/935,428

(22) Filed: Sep. 8, 2004

(30) Foreign Application Priority Data
Sep. 12, 2003 (JP) JP2003-321301
Sep. 12, 2003 (JP) JP2003-321302

(51) Int. Cl. H04L 9/00

(52) U.S. Cl. 713/200

(57) ABSTRACT

The present invention at leas comprises an input section 10 for inputting a file, specific media information generation section 12 for generating specific media information, copy restricted file identification section 13 for identifying whether the file is a copy restricted one or not, file conversion section 14 for scrambling the inputted file into a format that can be played back on a specific program, and file recording section 16 for writing the scrambled file or inputted file into the logical address area of a recording media and also writing the specific media information into an area other than the logical address area. If the file is a copy non-restricted one, it is recorded as it. If the file is a copy restricted one, a scrambled file is recorded and the specific media information is written into an area other than the logical address area.

### TECHNICAL FIELD

The present invention relates to a data player and playing program for playing back a file recorded on a recording media and to a data recorder and recording program for recording a file on a recording media.

### BACKGROUND

Various services relating to photography have been offered these days. For example, when a user takes photos by a digital camera, he can brings in the digital camera or media of the digital camera on which image files of the photos are recorded to a photo shop such as minilab and writes the image files recorded on the digital camera or media onto a recording media such as CD-R or DVD-R by section of an un-manned terminal (kiosk) in the shop or a terminal of the shop (for example, the Japanese Patent Application Laid-open Publication No. Hei 05-182373 (1993), pages 4-6, FIG. 3).

There is available another service that, when a user takes photos by a film type camera and brings in the finished films to a photo shop such as minilab, the shop, after developing the film, reads image data by section of an image reader such as scanner and writes them on a recording media such as CD-R or DVD-R, which is then offered to the user.

There is also available another service that the image files read from a digital camera, media or film are converted into a file format that can be played back on an image player such as DVD player or DVD recorder and then the original image files together with the converted image files are written on a recording media such as CD-R or DVD-R.

Then, the user can utilize the image files either by setting the recording media containing the image files in a personal computer so as to display and edit the image files or process the images by section of an application such as slide show program or by setting the recording media in an image player so as to display the image files. The above image files are not only utilized by the user himself but also used as a present to his friend to whom he wants to show the photos.

Quite a few personal computers of the latest models have a function of writing data on a recording media such as CD-R and DVD-R, and so the recording media provided by the above services can be copied by section of this write function as a present to a friend. However, if illegal copy like the above is allowed, expanded utilization of the above services is hindered and resultantly profit of the service providers is ruined.

If image files to be recorded on a recording media are based on a photo image photographed by a user himself, the user can record them on a recording media without any restriction. However, if copying the image files is restricted, for example, if the use of the image files is permitted only to a specified user or if a copyright is created with the image files, a protective measures is needed so that users cannot copy them freely.

Therefore, when image files are recorded on a recording media and the media is provided to users in the above services, such protective measures is adopted that the image files are converted into a format that can be played back only on a specific program and also the identification information for running the specific program is written on the recording media in a format that cannot be copied. Even when the recording media is copied, since the identification information is not copied because of the above measures, illegal copy of the recording media can be-prevented effectively.

If the specific program is installed on a device that plays back the recording media prepared by the above method, the image files converted using the specific program can be restored and displayed provided that the identification information is recorded on the recording media. However, since all recording media are not always prepared by the above method and so there can be a recording media on which inputted image files are written as they are, it may happen that, although the recording media has been acquired in a legal manner, those image files cannot be played back because the identification information is not recorded therein.

In addition, each time when an image file is written on a recording media, it is troublesome for a user to check whether the image file is a copy restricted one or not and it is too severe for a user to make a judgment as above. Since a device that enables to write data on a recording media by a simple operation (such as portable writer) has become popular these days, it is necessary to establish a system that prevents the copy restricted image files from being copied freely. This problem lies not only with image files but also with other files including music files, contents, and applications to be downloaded through the Internet.

### SUMMARY

The present invention is made in view of the above problems and the main object is to offer a data player and playing program that can be used for both a recording media on which files converted into a format playable only on a specific program are recorded and a recording media on which files are recorded without such conversion, and to offer a data recorder and recording program which can automatically identify whether the files recorded on the recording media are copy restricted ones or not.

A data recorder of the present invention at least comprises an input section for inputting a file, file identification section for identifying whether the inputted file is a copy restricted one or not, conversion section for converting the copy restricted file into a format that can be played back only on a specific program, recording section for writing the file on a recording media if the inputted file is not a copy restricted one or writing the converted file along with the information for running the specific program on a recording section if the inputted file is a copy restricted one.

In addition, the above recording section of the invention can be so constructed that the inputted file or converted file is written into the logical address area of the recording media and the date for running the specific program is written in an area other than the logical address area of the recording media.

In addition, in this invention, the copy restricted file can be a file in or to which the information showing that only a legally rightful person is allowed of copying is described or attached or a file which can be restored only by a predetermined procedure, and if the copy restricted file is a file that can be restored only by a predetermined procedure, the conversion section firstly restores the inputted file by the predetermined procedure and then converts it into a format that can be played back only on a specific program.

In addition, the data recording program of the invention uses a computer to function at least as the file identification section for identifying whether the inputted file is a copy restricted one or not.

In addition, the data recording program of the invention uses a computer to function at least as an input section for inputting a file, file identification section for identifying whether the inputted file is a copy restricted one or not, conversion section for converting the copy restricted file into a format that can be played back only on a specific program, recording section for writing the file on a recording media if the inputted file is not a copy restricted one or writing the converted file along with the information for running the specific program on a recording section if the inputted file is a copy restricted one.

The data recorder of the invention identifies whether an inputted file is a copy restricted one or not by checking if the information showing that only a legally rightful person is allowed of copying because of an established copyright or the like has been described in or attached to the file or if the file has been so organized that it can be restored only by a predetermined procedure, and if the file is a copy restricted one, it scrambles and records the file on a recording media so that the file can be restored only by a predetermined procedure and also records the identification information to be referred to on the specific program on the recording media, but if the file is not a copy restricted one, it records the file on the recording media as it is without scrambling. Accordingly, illegal copying of files that need to be protected of their copyright can be prevented and, furthermore, users are allowed to record a file on a recording media without knowing whether it is a copy restricted file or not.

In addition, the data player of the invention is a data player for playing back a file recorded on a recording media, at least equipped with a judgment section for judging whether the file has been converted into a format that can be played back only on a specific program.

In addition, the data player of the invention is a data player for playing back a file recorded on a recording media, at least equipped with a judgment section for judging whether the file has been converted into a format that can be played back only on a specific program, restoration section for restoring the file to an original format if the file is judged a converted one, and a playback section for playing back the file recorded on the recording media or the file restored as above.

In addition, the data playing program of the invention uses a computer to function as a judgment section for judging whether the file recorded on a recording media has been converted into a format that can be played back only on a specific program.

In addition, the data playing program of the invention uses a computer to function as a judgment section for judging whether the file recorded on a recording media has been converted into a format that can be played back only on a specific program, restoration section for restoring the file to an original format if the file is judged a converted one, and a playback section for playing back the file recorded on the recording media or the file restored as above.

In the present invention, the judgment section can be so constructed that it judges the file has been converted in case the identification information of the recording media to be referred to on the specific program is recorded into an area other than the logical address area of the recording media.

In addition, in the present invention, the judgment section can also be so constructed that it judges the file has been converted in case the information showing that the file has been converted is recorded in the logical address area of the recording media.

In addition, in the present invention, such a construction is also available that the file is judged a converted one in case the extension of the file recorded on the recording media is an extension recorded beforehand.

In addition, in the present invention, such a construction is also available that the file is judged a converted one in case the file recorded on the recording media cannot be restored by other programs.

As explained above, the data player and playing program automatically judge whether a file such as image, content and application recorded on a recording media has been scrambled (that is, converted into a format that can be played back only on a specific program) or not and play back the file as it is if the file is not a scrambled one but, if it is a scrambled one, restore the file using the specific program and then play it back. Accordingly, users are allowed to record a file on a recording media without knowing what format the file recorded on the recording media has. The data player of the present invention may be a portable player, single-purpose playback box, or DVD player.

### BRIEF DESCRIPTION OF THE DRAWINGS

FIG. 1 is an overview showing the construction of the data recorder and player according to an embodiment of the present invention.

FIG. 2 is a block diagram showing the function of the data recorder according to an embodiment of the present invention.

FIG. 3 is a flowchart showing the steps of preparing a data recording media using the data recorder according to an embodiment of the present invention.

FIG. 4 is a figure showing the data recording area on the data recording media according to an embodiment of the present invention.

FIG. 5 is a figure showing the data recording area on the data recording media according to an embodiment of the present invention.

FIG. 6 is an overview showing another construction of the data recorder according to an embodiment of the present invention.

FIG. 7 is an overview showing another construction of the data recorder according to an embodiment of the present invention.

FIG. 8 is a block diagram showing the construction of the data player according to an embodiment of the present invention.

FIG. 9 is a flowchart showing the steps of playing back an image file using the data player according to an embodiment of the present invention.

FIG. 10 is a cross-sectional view showing the construction of a recording media (CD-R).

### DESCRIPTION OF THE PREFERRED EMBODIMENT

A preferred embodiment of the data recorder of the present invention at least comprises an input section for inputting a file from a digital camera or media or via a communication network, a file identification section for identifying whether the inputted file is a copy restricted one or not, a file conversion section for scrambling the inputted file into a format that can be played back only on a specific program, a specific media information generation section for generating specific media information, and file recording section for writing the scrambled file into the logical address area of a recording media and also writing the specific media information generated by the specific media information generation section in an area other than the logical address area of the recording media; where the file is written as it is on the recording media if the file is not a copy restricted one while the scrambled file is recorded in the logical address area and the specific media information to be used in the specific program for playing back the scrambled file is written in an area other than the logical address area if the file is a copy restricted one. Accordingly, illegal copying can be prevented and, furthermore, users are allowed to record a file without knowing whether it is a copy restricted one or not.

[Embodiment]

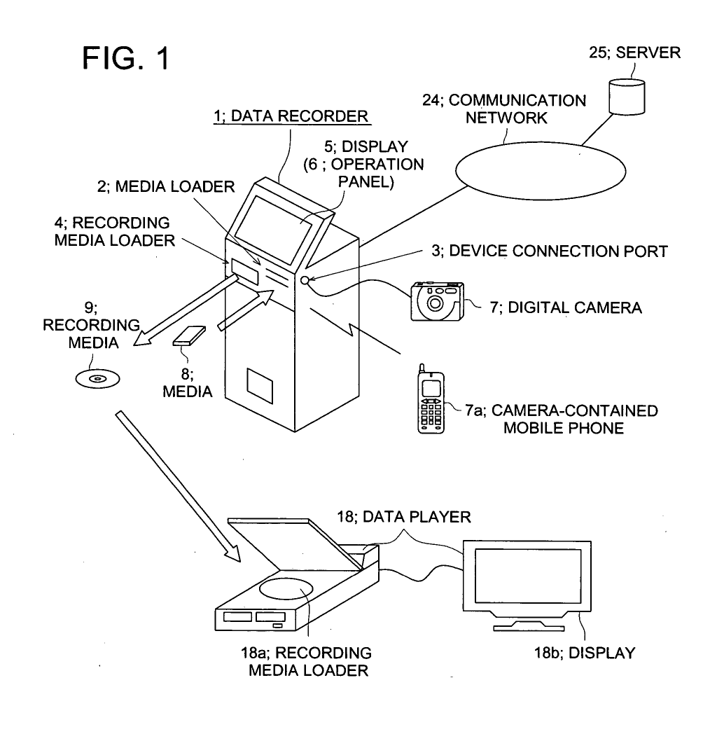

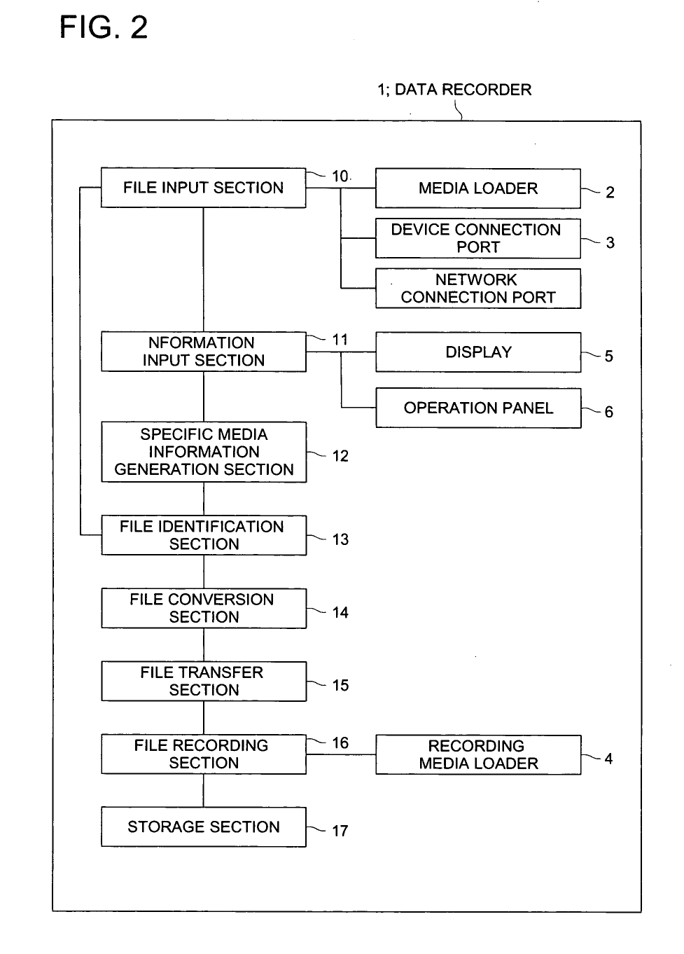

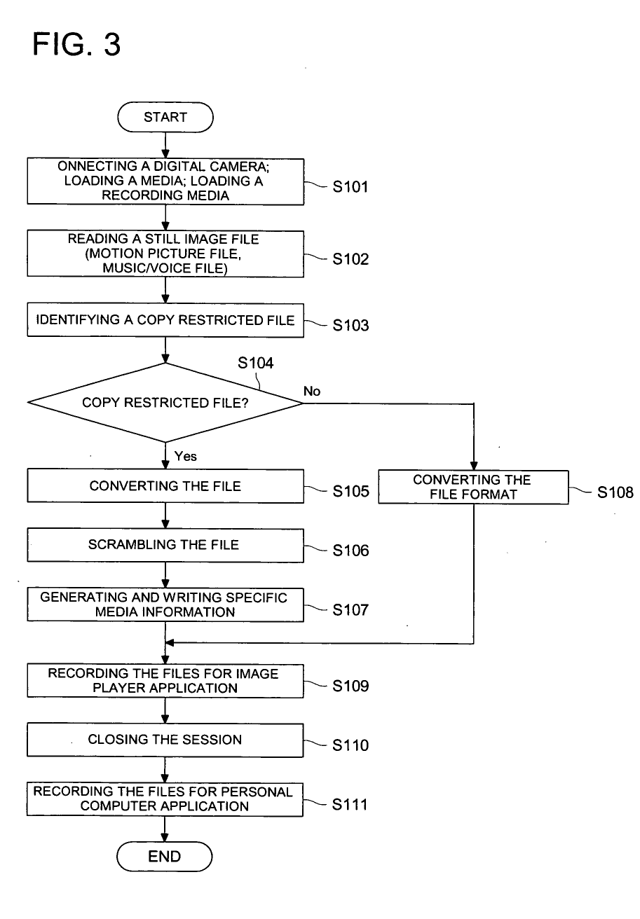

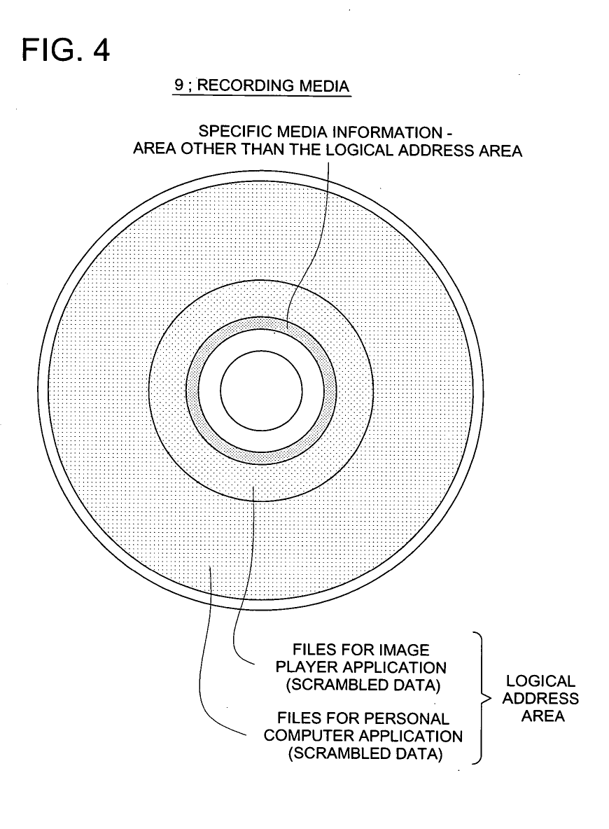

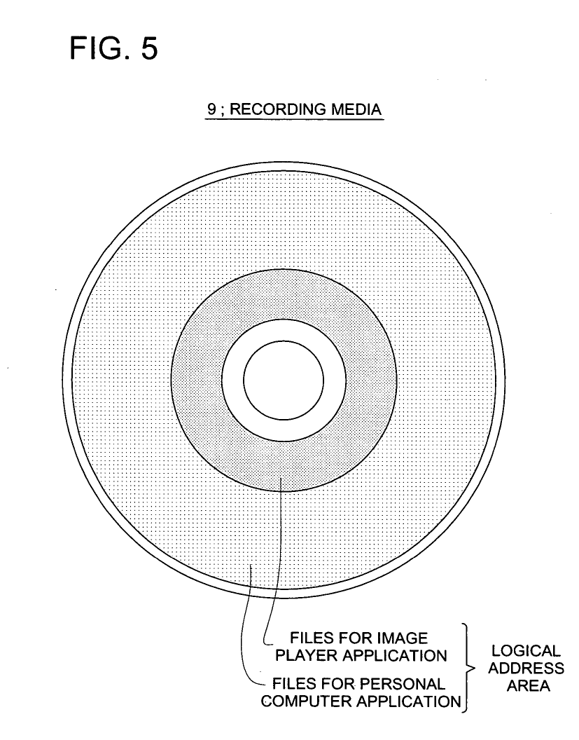

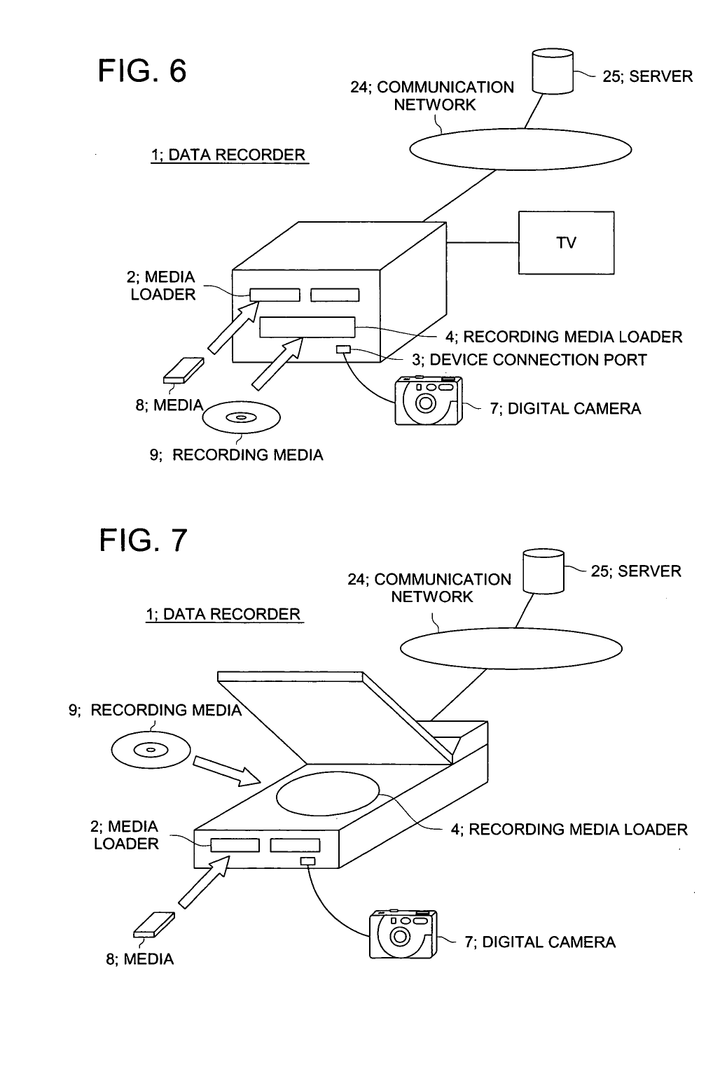

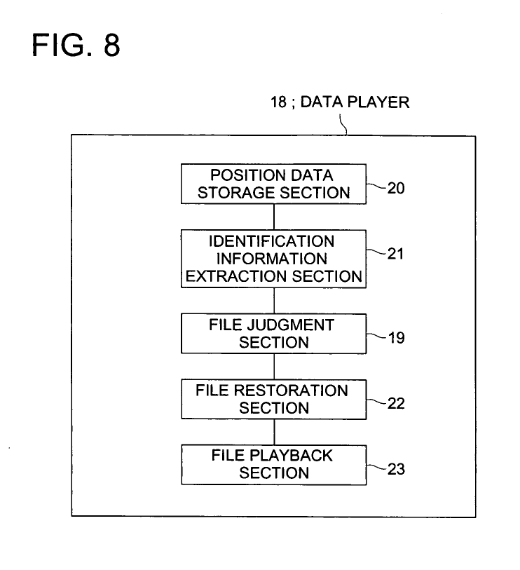

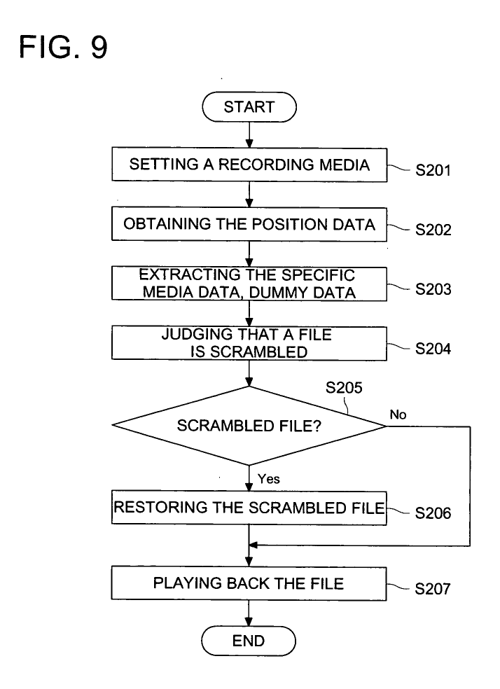

In order to describe the above preferred embodiment in detail, an embodiment of the data player and playing program of the invention is described hereunder, using FIG. 1 to FIG. 9. FIG. 1, FIG. 6 and FIG. 7 show a typical construction of the data recorder and player according to an embodiment of the present invention; and FIG. 2 is a block diagram showing the function of the data recorder. FIG. 3 is a flowchart showing the steps of data recording in this embodiment; and FIG. 4 and FIG. 5 are figures each showing the file recording area on the data recording media. FIG. 8 is a block diagram showing the construction of the data player of this embodiment; and FIG. 9 is a flowchart showing the steps of playing back an image file using the data player.

To start with, the system configuration of the present invention is described hereunder, using FIG. 1. The data recorder 1 of this embodiment comprises a file input section including a media loader 2 for loading a recording media for digital camera or camera-contained mobile phone (hereinafter called the media 8) such as smart media, Compact Flash (registered trademark), Memory Stick (registered trademark), SD memory card, and multi-media card, a device connection port 3 for connecting with a photographing device such as digital camera 7 or camera-contained mobile phone 7a (digital camera 7 represents both in the explanation hereinafter) with cable, by wireless or by infrared, and a network connection port for downloading a file from a server 25 via a communication network 24 such as the Internet; a recording media loader 4 for loading a recording media 9 such as CD-R and DVD-R for recording a still image file, motion picture file, music/voice file, content file or application file (hereinafter, simply called as a file) downloaded from the server 25; operation panel 6 for operating the buttons, keyboard and mouse; and display 5 such as LCD or CRT (in the figure, a touch panel that serves both as the operation panel 6 and display 5 is shown). The data player 18 of this embodiment comprises a recording media loader 18a for loading a recording media 9 such as CD-R and DVD-R on which the file is recorded and display 18b for playing back the file. Thus, the file recorded on the recording media prepared on the data recorder 1 or other recorder is played back on the data player 18.

FIG. 2 is a block diagram showing the functions of the above data recorder 1. That is, the recorder is equipped with a file input section for inputting a file (for example, still image file or music/voice file that can be played back on a personal computer) by section of the media loader 2, device connection port 3 and network connection port; an information input section 11 including the display 5 and operation panel 6; a file identification section 13 for identifying whether the inputted file is a file in or to which header the information showing that only a legally rightful person is allowed of copying because of an established copyright or the like has been described or attached or which has been so organized that it can be restored only by a predetermined procedure (hereinafter, these files are called the copy restricted file as a whole); a specific media information generation section 12 for generating the information to be referred to by the specific program for identifying the recording media 9 (hereinafter called the specific media information); a file conversion section 14 for converting the inputted file (for example, still image file) into a file format that can be played back on an image player such as DVD player or DVD recorder (for example, motion picture file, slide show file) and also for scrambling the inputted file or the file converted for an image player in accordance with the input information from the information input section 11; a file transfer section 15 for controlling the recording sequence of files; a file recording section 16 for writing the file transferred by the file transfer section 15 into a specified area on the recording media 9 loaded on the recording media loader 4; and a storage section 17 for storing the file to be written by the file recording section.

Although the recording media loader 4 is used as a section of recording a file on a recording media 9 in FIG. 1, it is permissible to load a recording media containing recorded files such as content and use the loader 4 as a section of inputting a file from the recording media. In addition, although FIG. 1 shows a kiosk type data recorder 1 that can be installed in a shop such as photo shop or convenience store, the type of the data recorder is optional and it can be a compact device a user can utilize at home for recording files on a recording media 9; for example, a private set-top box as shown in FIG. 6 or portable writer as shown in FIG. 7 will do, or even a DVD recorder will do. The data recorder 1 can be so constructed as to contain each of the above section as hardware, but it is also possible to prepare a recording program for using a computer to function at least as the file input section 10 and file identification section 13, and then install and run the recording program on the data recorder 1.

The steps of recording a file on the recording media 9 by section of the above data recorder 1 are described hereunder, using the flowchart in FIG. 3. The steps below describe a case where two different types of files are recorded on the recording media 9 so that the read file can be played back on both personal computer and image recorder, but they are applicable to a case where a file that can be played back only on either one is recorded on the recording media 9.

In step S101, a media 8 is loaded on the media loader 2 of the data recorder 1, a digital camera 7 is connected with the device connection port 3, or the network connection port is connected with the communication network 24, and a recording media 9 is loaded on the recording media loader 4. Next, in step S102, a file stored in a specified area of the digital camera 7 or media 8 or a file recorded in the server 25 (a still image file recorded in the digital camera 7 or media 8 in this description) is read.

In step S103, the file identification section 13 identifies whether the inputted file is a copy restricted one or not by checking if the information showing that only a legally rightful person is allowed of copying because of an established copyright or the like has been described in the header of the file, if the information is attached to the file, or if the file has been so organized that it can be restored only by a predetermined procedure (for example, if the file has been so converted that it can be played back only on a specific program, or if entry of any ID information or password is required for playing back the file). The process of identifying a copy restricted file is not limited to the above but, for example, a file that comes under a list stored in the storage section 17 can be judged a copy restricted one.

If the inputted file is judged a copy restricted one in step S104, the read still image file is converted into a file in different format (into a motion picture file of MPEG 1 or MPEG 2 format that can be read by an image player such as DVD player or DVD recorder or into a V-CD format file or DVD-Video format file in this description) in step S105 by the file conversion section 14 as needed. There is no limitation to the process of generating a motion picture file from a still image file; for example, if a still image file is to be displayed as a slide show, the motion picture file can be generated by adding differential 0 data, the time needed for slide display to the still image file or by adding differential data, based on the slide effect specified in the slide show program, to the still image file. If the inputted file has been so organized that it can be restored only by a predetermined procedure, the above step is taken after the file is restored.

In step S106, part or whole of the file inputted or converted by the file conversion section 14 for use on an image player is scrambled. In this description, scrambling section conversion of the file format so that a file cannot be played back unless a specified application (specific program) is used, including various processes such as alteration of data arrangement in the file, division of the file, and change of extension of the file to a specific one. There is a case as above that whole of the file to be recorded on the recording media 9 is not scrambled, which is because some of the Video-CD format data and DVD-Video format data cannot be copied when the recording media 9 is to be copied on a personal computer and so they do not require scrambling. If the inputted file has already been scrambled, the scrambled file can be used as it is without restoring it, and hence scrambling in step S106 is not necessary.

Next, in step S107, the specific media information generation section 12 generates the specific media information for identifying the recording media 9. The content of the specific media information is not limited, and it can be for example the name of the manufacturer of the recording media 9. Furthermore, it can be a unique description so that the specific media information should not duplicate among multiple recording media 9. The specific media information will do if it is recorded in a format that can be recognized by the specific program, and so it is preferable the information is recorded not in a file format but as data so that the operating system of personal computer cannot recognize it.

Next, the specific media information is recorded on the recording media 9. This specific media information is provided to prevent illegal copying of files. If the location or content of the recorded specific media information can be easily known to users, the information itself can be copied, resulting in unsuccessful prevention of illegal copying. In this embodiment, therefore, at least part of the specific media information is written into an area that cannot be accessed by the operating system of personal computer (that is, area other than the logical address area), or to be more specific, into an area inside the logical address area of a disk type recording media.

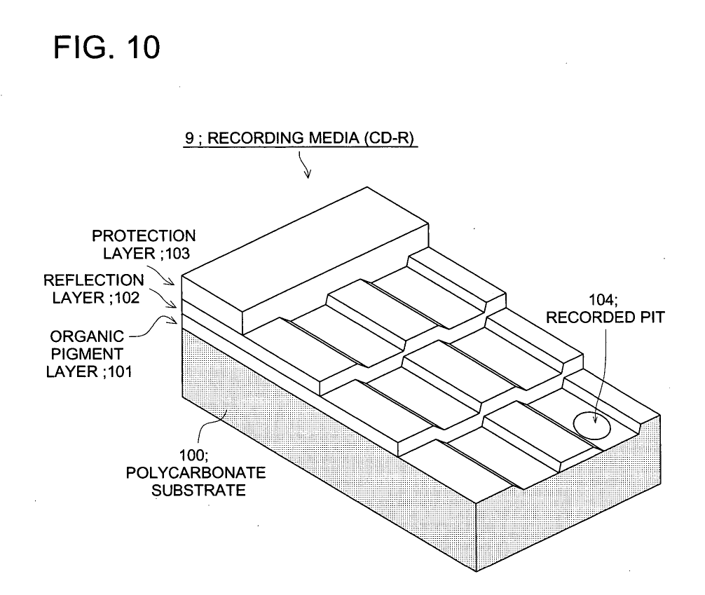

The structure of a general recording media 9 is described hereunder, using FIG. 10. CD-R is made of a polycarbonate substrate 100 on which an organic pigment layer 101 using cyanine, phthalocyanine or azo, reflection layer 102 using silver and protection layer 103 are laminated. Then, laser beam of specified power is irradiated onto the organic color layer 101 so as to deform the substrate by decomposing the pigment, and thereby pits are generated and data is recorded. Since the optimum laser power level depends upon the type of the laser head irradiating the laser beam or material of the organic pigment layer 101, the disk drive side needs to recognize what pigment is used in manufacturing the CD-R in order to ensure reading and writing the data. Accordingly, information such as the type of pigment used in the CD-R and manufacturer's name of the CD-R is written into the innermost area of the recording media 9 during the manufacture. Then, firmware in the disk drive reads out the information and controls the laser head individually so as to adjust the laser power. The innermost area of a disk is used as the area for recording the information relevant to the properties of the CD-R as above. Since the area is generally inaccessible for an operating system, the specific media information of the recording media 9 is written into this area (area other than the logical address area) in this embodiment so that the specific media information itself cannot be copied.

In this embodiment, if a file is to be scrambled, specific media information is generated by the specific media information generation section 12 and written into an area other than the logical address area of the recording media 9 so that the file can be judged a scrambled one. However, it is also permissible that dummy data in any format (preferably, a format that cannot be recognized by the operating system of personal computer) showing whether the file has been scrambled or not is recorded in the logical address area where files for personal computer application and image player application are recorded so that the file is judged a scrambled one if the dummy data is recorded in the logical address area of the recording media 9. It is also possible that the extension of a file is converted so that the file can be played back only on a specific program.

If the inputted file is judged a copy non-restricted one in step S104, the read still image file is converted into another file in different format, if necessary, in the same manner as above by the file conversion section 14.

Next, in step S109, the file transfer section 15 transfers the file scrambled by the file conversion section 14 together with relevant files (hereinafter, all these are called the files for image player application as a whole) into a specific folder for writing provided in the storage section 17. Then, the file recording section 16 reads the files for image player application from the folder and records them into an area inside the logical address area of the recording media 9. If the file is recorded on a CD-R using an image format MPEG 1 or MPEG 2 for motion picture file, a recording media 9 in the Video-CD format can be produced. If the file is recorded on a DVD-R using an image format MPEG 2 for motion picture file, a recording media 9 in the DVD-Video format can be produced.

Next, in step S110, the file recording section 16 closes its session before recording a file for personal computer application so as to allocate the file area available for the image player.

Next, in step S111, the file transfer section 15 transfers the file scrambled by the file conversion section 14, application for displaying the still image file as slide show, and setup file for the slide show (hereinafter, all these are called the files for personal computer application as a whole) into a specific folder for writing provided in the storage section 17. Then, the file recording section 16 reads the files for personal computer application from the folder and records them into an area outside the formerly recorded files for image player application on the recording media 9. Thus, a series of writing processes are complete.

The recording media 9 prepared by the above steps is configured as shown in FIG. 4 and FIG. 5. That is, when a file is subjected to scrambling, specific media information of a specified format (preferably, not a file format but a data format) is recorded in the innermost area other than the logical address area on the disk type recording media 9, the files for image player application including the scrambled file (data in a Video-CD format or DVD-Video format may not necessarily be scrambled) are recorded in the inner part of the logical address area outside the above area, and the files for personal computer application including the scrambled file are recorded in the outer area than the above as shown in FIG. 4. In case dummy data is employed, the dummy data in a format that cannot be recognized by the operating system of personal computer is recorded in the logical address area. If the file is not subjected to scrambling, the files for image player application are recorded in the inner part of the logical address area and the files for personal computer application are recorded outside the above as shown in FIG. 5.

For the sake of definite description, all of the inputted files are regarded either copy restricted files or copy non-restricted files in the above steps, but it is possible that some of the inputted files are copy restricted ones. If this applies, the above flow shall be so changed that only the copy restricted files are scrambled in step S106 and both scrambled files and non-scrambled files are recorded on the recording media 9 in step S109 or step S111. In addition, although the specific media information is supposed to be written on the recording media 9 by the data recorder in the above steps, it is possible that a recording media 9 on which the specific media information has already been written is supplied to a user. For example, since the area in which the specific media information is to be written is an area where information such as the type of pigment and manufacturer's identification is recorded beforehand in the manufacturing process of the recording media 9, it can be requested to the manufacturer to write the specific media information together with the above information. If this can be done, because the specific media information is recorded by pressing, reliability of the record can improve. In addition, since the data recorder 1 needs not be equipped with the specific media information generation section 12 and hence step S107 in FIG. 3 for writing the specific media information can be eliminated, the construction and recording procedure of the data recorder 1 can be simplified.

Next, the steps of playing back a file on the data player 18 using the recording media 9 on which a scrambled file generated by the data recorder 1 is recorded of recording media 9 on which the inputted file is recorded as it is are described hereunder, using the flowchart in FIG. 9.

In step S201, the user sets the recording media 9 in the recording media loader 18a of the data player 18. As shown in FIG. 8, the data player at least comprises a position data storage section 20 for storing the record position of the specific media information and dummy data; an identification information extraction section 21 for extracting the specific media information and dummy data by referring to the position data stored in the position data storage section 20; a file judgment section 19 for judging whether the file recorded on the recording media 9 is scrambled or not from the content of the specific media information and dummy data, type of extension of the file, and information as to whether the file can be played back on other program; a file restoration section 22 for restoring the scrambled file to a original file; and a file playback section 23 for playing back the restored file or inputted file. Each of the above section can be provided as hardware of the data player, but it is also possible to prepare a playback program for using a computer to function at least as the file judgment section 19, and then install and run the program on the data player 18 or personal computer.

Next, in step S202, the identification information extraction section 21 obtains the position data (for example, physical address) stored in the position data storage section 20. Then, in step S203, it refers to the obtained position data and extracts the specific media information and dummy data recorded at the position. As explained above, the specific media information cannot be accessed by the operating system of personal computer because it is recorded in an area other than the logical address area and the dummy data is recorded in a format that cannot be recognized by the operating system of personal computer. Accordingly, they can be extracted only by the identification information extraction section 21 that has obtained their position data. The specific media information and dummy data need not necessarily be recorded as sequential data but can be recorded as discrete data. If this applies, the specific media information and dummy data are obtained by combining the data on multiple positions specified by the position data.

Then, in step S204, the file judgment section 19 judges that the file is a scrambled one if the specific media information or dummy data is recorded on the recording media 9, and the scrambled file is restored to an original format by the file restoration section 22 in step S206. There is no limitation to the process of restoring the scrambled file; for example, if the file has been coded according to a specified rule, the file is decoded according to the rule, and if the file has been divided into pieces, the divided pieces are gathered. In addition, the specific media information or dummy data can be utilized for restoring the scrambled image file; for example, it is possible that key information for decoding is recorded in the specific media information or dummy data and that a coded file is decoded using this key information.

It is also possible to utilize the extension to judge whether a file is a scrambled one or not. If this applies, after the recording media 9 is set in step S201, the file judgment section 19 checks the extension of the file recorded on the recording media 9 and if the extension agrees with a stored one, the file is judged a scrambled one in step S204. Whether a file is a scrambled one or not can also be judged by playing back the file using other program (for example, an image display program commercially available in the market). If this applies, after the recording media 9 is set in step S201, the file judgment section 19 attempts to actually play back the file on preinstalled other program and if it cannot be played back, the file is judged a scrambled one in step S204.

After the above, the file playback section 23 displays the restored file or original file on the display 18b. While a scrambled file can be restored each time it is played back, it is also possible to restore all the files recorded on the recording media 9 at a time and store them in a temporary storage (storage section 17, for example) of the data player 18, and read each file requested for playback from the temporary storage and display. Restoring a scrambled file each time it is to be displayed involves a problem that the time needed for playing back the file is long. However, since the restored file is not stored in a personal computer, possible illegal copying of the restored file can be prevented.

As explained above, the data player 18 of this embodiment extracts specific media information written in an area other than the logical address area or dummy data written in the logical address area on the recording media 9, by referring to the position data stored in the position data storage section 20, and judges that the file is a scrambled one if specific media information or dummy data is written on the recording media 9; or checks the extension of the file and judges that the file is a scrambled one if the extension agrees with a stored one; or attempts to play back the file on other program and judges that the file is a scrambled one if it cannot be played back; and then the scrambled file is restored to an original one by the file restoration section 22. Accordingly, regardless of whether a scrambled file is recorded on a recording media 9 or an inputted file is recorded as it is on a recording media 9, the file on the recording media 9 can be played back on the data player 18. Thus, users' convenience is very much enhanced.

Each of the above embodiments describes playing back a file including image file read from digital camera 7, media 8 or film, music/voice file, content file, and application file. However, the present invention is not limited thereto but applicable similarly to playing back other files.

According to the data recorder and recording program of the present invention, illegal copying of recording medium can surely be prevented. According to the data player of the invention, any file containing image, content, or application recorded on a recording media can be played back regardless of whether it is a scrambled one or not.

This is because the data recorder does not simply record an inputted file as it is on a recording media such as CD-R but automatically checks whether the inputted file is a copy restricted one or not and, if it is a copy restricted one, scrambles the file and records it on the recording media, and at the same time, writes specific media information for identifying the recording media in an area other than the logical address area that cannot be accessed by the operating system of personal computer and writes dummy data on the recording media in a format that cannot be recognized by the operating system of personal computer. If the file is not a copy restricted one, it records the inputted file as it is on the recording media. Since a copy non-restricted file can be played back freely and a copy restricted file cannot be played back unless a recording media recorded with identification information is used along with a specific program, illegal use of copy restricted file can surely be prevented. In addition, users can record a file on the recording media without knowing whether the file is a copy restricted one or not.

The above is also because the data player automatically judges whether the file is a scrambled one or not by referring to recorded identification information, type of the extension of the file, and availability for playing back the file on other program, and plays it back as it is if not a scrambled one but, if a scrambled one, restores it and then plays it back.

1. A data recorder comprising:
an input section for inputting a data of file;
a file identification section for identifying whether the inputted file is a copy restricted one or not;
a conversion section for converting the copy restricted file into a format that can be played back on a specific program; and
a recording section for storing the file on a recording media if the inputted file is not a copy restricted file, or storing the converted file and the information for running the specific program on the recording media if the inputted file is a copy restricted file.

2. The data recorder of claim 1, wherein the recording section for inputted file or converted file is storing into the logical address area of the recording media and the date for running the specific program is written in an area other than the logical address area of the recording media.

3. The data recorder of claim 1, wherein the copy restricted file includes at least one of a file to which the information showing that a legally rightful person is allowed of copying is described or attached and a file which can be restored by a predetermined procedure.

4. The data recorder of claim 1, wherein the conversion section restores the inputted file by the predetermined procedure and converts it into a format that can be played back on a specific program, if the copy restricted file is a file that can be restored by a predetermined procedure.

5. A data recording program to control a computer to function as a data recorder comprising;
an input section for inputting a data of file;
a file identification section for identifying whether the inputted file is a copy restricted one or not;
a conversion section for converting the copy restricted file into a format that can be played back on a specific program; and
a recording section for storing the file on a recording media if the inputted file is not a copy restricted file, or storing the converted file and the information for running the specific program on the recording media if the inputted file is a copy restricted file.

6. The data recording program of claim 5, wherein the recording section for inputted file or converted file is storing into the logical address area of the recording media and the date for running the specific program is written in an area other than the logical address area of the recording media.

7. The data recording program of claim 5, wherein the copy restricted file includes at least one of a file to which the information showing that a legally rightful person is allowed of copying is described or attached and a file which can be restored by a predetermined procedure.

8. The data recording program of claim 5, wherein the conversion section restores the inputted file by the predetermined procedure and converts it into a format that can be played back on a specific program, if the copy restricted file is a file that can be restored by a predetermined procedure.

9. The data player comprising;
a data file playing section for playing back a file recorded on a recording media,
a judgment section for judging whether the file has been converted into a format that can be played back on a specific program,
a restoration section for restoring the file to an original format if the file is judged a converted one,
a playback section for playing back the file recorded on the recording media or the file restored.

10. The data player of claim 9, wherein the judgment section for judging the file converted in case the identification information of the recording media to be referred to on the specific program is recorded into an area other than the logical address area of the recording media.

11. The data player of claim 9, wherein the judgment section for judging the file converted in case the information showing that the file converted is recorded in the logical address area of the recording media.

12. The data player of claim 9, wherein the judgment section for judging the file converted in case the extension of the file recorded on the recording media is an extension recorded beforehand.

13. The data player of claim 9, wherein the judgment section for judging the file converted in case the file recorded on the recording media cannot be restored by other programs.

14. A data playing program to control a computer to function as a data recorder comprising;
a data file playing section for playing back a file recorded on a recording media,
a judgment section for judging whether the file has been converted into a format that can be played back on a specific program,
a restoration section for restoring the file to an original format if the file is judged a converted one,
a playback section for playing back the file recorded on the recording media or the file restored.

15. The data playing program of claim 14, wherein the judgment section for judging the file converted in case the identification information of the recording media to be referred to on the specific program is recorded into an area other than the logical address area of the recording media.

16. The data playing program of claim 14, wherein the judgment section for judging the file converted in case the information showing that the file converted is recorded in the logical address area of the recording media.

17. The data playing program of claim 14, wherein the judgment section for judging the file converted in case the extension of the file recorded on the recording media is an extension recorded beforehand.

18. The data playing program of claim 14, wherein the judgment section for judging the file converted in case the file recorded on the recording media cannot be restored by other programs.
